(19) United States
(12) Patent Application Publication
(10) Pub. No.: US 2010/0276382 A1
(43) Pub. Date: Nov. 4, 2010

(54) MODULAR MAGNETIC FIXTURE SYSTEM

(76) Inventors: Dario Cesar Antonioni, Santa Monica, CA (US); John Walter Ford, Attadena, CA (US)

Correspondence Address: STETINA BRUNDA GARRED & BRUCKER, 75 ENTERPRISE, SUITE 250, ALISO VIEJO, CA, 92656, US

(21) Appl. No.: 12/815,191

(22) Filed: Jun. 14, 2010

Related U.S. Application Data
(63) Continuation-in-part of application No. 11/289,746, filed on Nov. 29, 2005, now abandoned.

(51) Int. Cl. A47F 1/04; H01F 7/00

(52) U.S. Cl. 211/59.2

(57) ABSTRACT

A customizable modular magnetic wall system is provided for displaying items while allowing a user to aesthetically configure and tailor the system to the user's needs. The system includes a magnetic backing plate and at least one module. The module includes a base portion and a utility member. The base portion of the module is magnetically securable at a plurality of positions on the backing plate. In addition, the utility member projects outwardly from the base portion and is sized and configured to receive the item. The module may include a shelf, hooks, and other various devices for displaying the item.

### CROSS-REFERENCE TO RELATED APPLICATIONS

The present application is a continuation-in-part of U.S. application Ser. No. 11/289,746 entitled “Modular Magnetic Fixture System” filed Nov. 29, 2005, the disclosure of which is incorporated herein by reference.

### STATEMENT RE: FEDERALLY SPONSORED RESEARCH/DEVELOPMENT

Not Applicable

### BACKGROUND

The following generally relates to display devices and, more specifically, to an customizable modular magnetic fixture system that includes magnetically-mountable modules useful for display purposes that may arranged in limitless configurations along a backing plate and do not require unsightly mounting fixtures.

Retailers often try to appeal to consumers by creating attractive displays for the merchandise they sell. These displays typically include shelving, tables, and racks that are constructed with tools. The displays may usually be adapted for different configurations, thus allowing the retailers reasonable flexibility in designing their displays. The ability to manipulate a display is important due to the frequently required changes for seasons, new clothing lines, new product lines, and various other reasons. Further, attractive and innovative displays are perhaps one of the most important tools used by retailers to attract passers-by into their store or for vendors to exhibit their products at trade shows. Therefore, whether retailers are targeting the occasional “window-shopper” or the in-store customer, their displays ought to be flexible, fashionable, and effective.

Diverse equipment used in constructing displays may be seen at almost any store. For example, clothiers use mannequins to model clothing. Inside, pants, shirts, and other garments may be neatly stacked on tables and shelves along the wall. Hangers and racks may also be used to hang the clothing. In other types of non-clothing stores, shelving is frequently hung to make efficient use of wall space and to maximize display space. However, unlike other more mobile equipment, such as tables and racks, shelving is often of limited utility because it is limited to certain assembly configurations and is difficult to drastically modify.

Shelving assemblies used for display and storage purposes are assembled utilizing several common elements. These elements include: mounting supports, shelf support elements, and a shelf. The mounting supports may typically consist of bars that are fastened to the wall with screws. This arrangement is very common for both commercial home uses. Basically, two bars are aligned vertical and parallel to one another—preferably in-line with studs from the wall—and several screws or nails are inserted through each of the bars and into the wall to secure the bars to the wall. Alternatively, the bars may be mounted horizontally, in a similar fashion. Next, the mounting supports include notches at a variety of positions or specifically designed cross-sections that are configured to receive the shelf support elements. The shelf support elements are attached to the mounting supports at any of the variety of positions or attached to the cross-section of the mounting element. Finally, the shelf is placed onto the shelf supports and items may be placed onto the shelf for display.

Several other wall display fixtures and assemblies exist in the prior art, but often only include small variations to the above-described shelving assembly. For example, although its unattractive appearance makes it unpopular for displays, peg board allows fixtures and shelves to be mounted thereon at numerous positions. When considering shelving assemblies and wall fixtures, these apparatuses commonly include a mounting element attachable to a wall and a support element securable to the mounting element. Another common wall mounted retail merchandising display system is the use of a “seat wall” consisting of a wall cover made of medium density fiber board (“MDF”), corian, plastic or aluminum. The wall cover has horizontal wedges on which display hooks, knobs or bars having a complimentary mounting element made of plastic, acrylic, aluminum, or similar materials may be slidably fixed.

Although these shelving assemblies are somewhat convenient and serve several important purposes for the average retailer, there are many limitations associated with such assemblies. Primarily, the retailer has limited configuration options. Configuration options are limited by the number of positions at which the shelf may be mounted, and specifically, by the arrangement of the mounting elements on the wall (which may themselves be limited by the arrangement of the studs in the wall). The result is a limited number of discrete positions and configuration options, regardless of whether peg board or multiple mounting elements are utilized. This particular drawback of prior art may often be frustrating for those retailers who require flexibility and ease in configuring their displays.

In addition, another drawback of the shelf assemblies and wall fixtures is the requirement of tools and stud support for adjustments and installation. Before installation, the retailer must be confident that the arrangement of the mounting elements will meet their needs, now and in the foreseeable future. In case the retailer wishes to change the overall arrangement, the retailer must use several tools to remove and reinstall the mounting elements. This process often leaves the wall in a state of disrepair, and paint and other touch ups may be required. Further, installation or reinstallation may be limited by the location of studs within the wall if the assembly or fixture is to be moderately load-bearing. Often, stud location limits the arrangement of the mounting elements to undesirable location that do not meet the needs of the retailer.

Further, one of the principal purposes of a display is to provide an attractive and appealing visual for customers. However, the aesthetic value of the display is lessened by the unnecessarily exposed mounting elements and fixtures that are not being utilized. For example, even though the shelf may be properly mounted on the mounting fixture (such as parallel vertical bars), the shelf only occupies a small portion of the available positions on the bars, thus leaving a pair of unattractive bare metal bars exposed on the wall and without any apparent value. In many establishments, an exposed mounting fixture completely detracts from the mood and visual effect that the retailer may be trying to achieve. Further, options such as peg board force the user to accept a hole-riddled wall texture in order to have the benefit of numerous mounting positions. As a result, retailers must either have an attractive mounting fixture, or plenty of merchandise to hide the mounting fixture from view. This predicament eliminates decorating options that many retailers long to exercise.

Therefore, there is an apparent need in the art for shelf assemblies and wall fixtures that allow for unlimited flexibility in mounting, adjusting, and decorating an existing wall structure. There is a need in the art for shelf assemblies and wall fixtures that are aesthetically attractive and eliminate exposure of unused portions of mounting elements. There is also a need in the art for a display system that allows the shelf assemblies and wall fixtures to be removed and reattached without causing damage to the wall, thus eliminating touch up work after reconfiguring.

### BRIEF SUMMARY

In order to remedy many of the limitations in the prior art, including those mentioned above, a modular magnetic wall system is provided. The system is preferably utilized in stores for displaying items, including any type of merchandise, clothing, cookware, electronic gadgets, home furnishings, etc., and may effectively enhance the decor of the store. The system may also be utilized in the exhibition of products by a vendor at trade shows. The system includes a backing plate and a module, but in preferred embodiments will include several modules of varying design, as discussed below. The module includes a base portion and a utility member. The base portion of the module is magnetically securable at a plurality of positions on the backing plate. In fact, because of its magnetic securement, the positions at which the base portion may be secured are virtually unlimited. In addition, the utility member projects outwardly from the base portion and is sized and configured to receive the item.

The system may be configured and designed to suit the various needs of a user. The module may include a magnetic element that is affixed to the base portion of the module. The magnetic element may be operative to magnetically secure the module at the plurality of positions on the backing plate. In this regard, the magnetic element may be made of various magnetic materials such as a neodymium magnet. Additionally, the magnetic element may be configured to include three magnets that are adhesively mounted to the module.

Furthermore, the utility member of the module may be configured to serve numerous purposes and to provide flexibility in the display of the items. For example, the utility member may include at least one hook, a notched bar, or a ledge for mounting a shelf thereon. In addition, the module of the system may further include a shelf that is sized and configured to be supported upon the ledge of the module. Other various uses and designs of the utility member may be implemented in order to satisfy the utility or aesthetic needs of the user.

In addition to providing improved utility and ease of use, the system may also be capably used in variously configured buildings. In order to install the system, the backing plate may be retrofitted to existing construction and be attachable to an existing wall. However, the backing plate may also be installed in new construction as well. Further, the backing plate may be mounted on a support sheet, such as MDF board. Additional modifications to facilitate use of the system may be made to the backing plate and support sheet such as including a lightening the support sheet by utilizing a series of perforations. Preferably, the backing plate should be at least 1/32 inch thick, and typically 1/16 to ¼ inch thick, which provides adequate magnetic attraction between the module and the magnetic backing plate.

Finally, the system may also be suited to the tastes and aesthetic needs of the user. In this regard, the backing plate may include a surface covering such powder coating, paint, wallpaper, suede, leather, and fabric. This additional feature provides distinct benefits by allowing the system to appear as a normal wall and to take on any appearance as desired by the user. These beneficial aspects including in embodiments of the present invention, as well as other beneficial features, will be further described below.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of an exemplary embodiment of a modular magnetic wall system including a backing plate and modules being magnetically secured to than the backing plate;

FIG. 2 is a cross-sectional view of the module including a base portion, a utility member configured as a ledge, a magnetic element, and a shelf mounted on the ledge;

FIG. 3 is a partial perspective view of the modular magnetic wall system wherein the backing plate is mounted on a support sheet;

FIG. 4 is a side view of the embodiment of the modular magnetic wall system illustrated in FIG. 3 wherein the utility member of the module includes a hook;

FIG. 5 is a rear perspective view of the module illustrated in FIGS. 1, 3, and 4 wherein the magnetic element comprises three magnets being adhesively mounted to the module;

FIG. 6 is a front view of the module illustrated in FIG. 5;

FIG. 7 is a side view of an embodiment of the module wherein the utility member includes a notched bar;

FIG. 8 is a front view of the embodiment of the module illustrated in FIG. 7;

FIG. 9 is a rear perspective view of the embodiment of the module illustrated in FIG. 2;

FIG. 10 is a rear perspective view of the embodiment of the module wherein the magnetic element is fastened to the base portion by a screw.

FIG. 11 is a rear perspective view of an alternative embodiment of the module illustrated in FIG. 9, illustrating a backing applied to the base portion as being partially detached therefrom;

FIG. 12 is a partial perspective view of a variant of the base portion which may be integrated into the module shown in FIG. 11;

FIG. 13 is a top perspective view of a magnet which may be used in conjunction with the base portion shown in FIG. 12;

FIG. 14 is a partial perspective view of a variant of the module having a gutter and non-stick pad to stabilize the bar portion to the backing plate; and

FIG. 15 is a cross-sectional view of an alternative embodiment of the module illustrated in FIG. 14.

### DETAILED DESCRIPTION

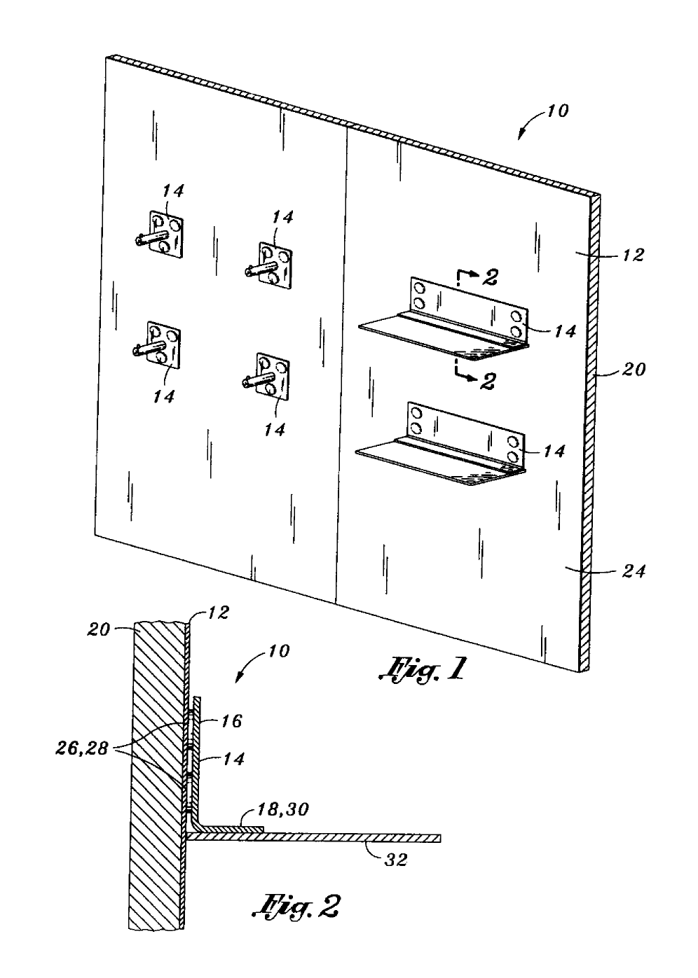

Referring now to the drawings wherein the showings are for purposes of illustrating a preferred embodiment of the invention only, and not for purposes of limiting the same, FIG. 1 is a perspective view of an exemplary embodiment of a modular magnetic wall system 10. The system 10 may be utilized in stores or at trade shows for displaying items. Such items may include any type of merchandise, clothing, cookware, electronic gadgets, home furnishings, etc. One of the many benefits of the system 10 is that the system 10 allows a user to manipulate the color and appearance of the system 10 to match decor and create an aesthetically pleasing appearance. The system 10 may be implemented in any variety of retail stores and other offices, buildings, etc. For example, the system 10 may be utilized in residential or commercial construction, so as to benefit individuals both in home and at the workplace. The system 10 may also be installed in pre-existing construction as well as in new construction.

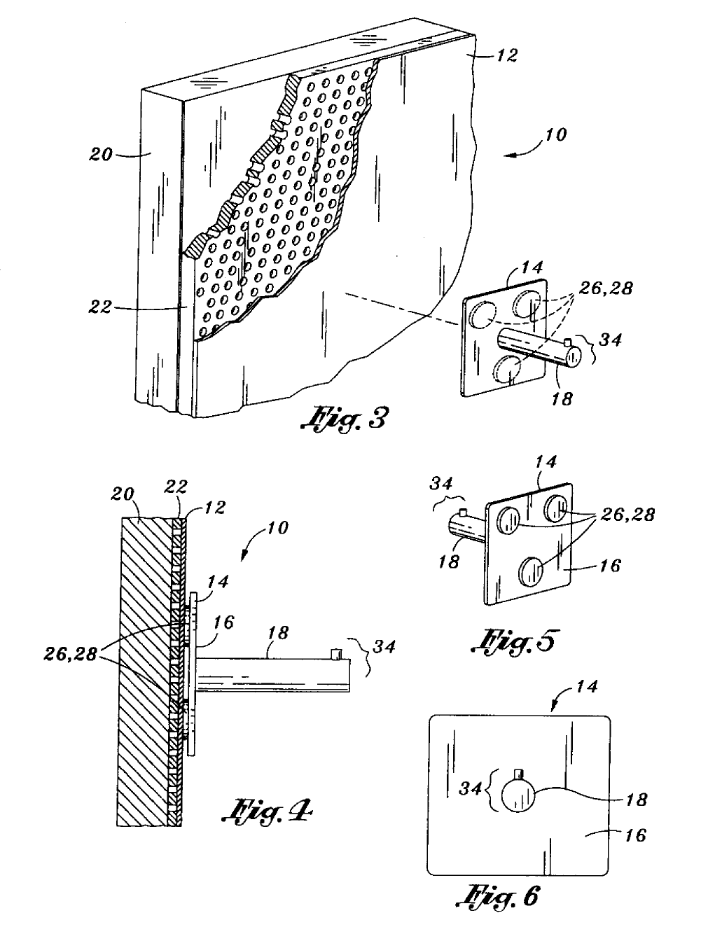

As shown in FIG. 1, the system 10 includes a metallic, backing plate 12 and at least one module 14. As illustrated by the exemplary embodiments in FIGS. 2 and 4, the module 14 includes a base portion 16 and a utility member 18, which are described in greater detail below. The base portion 16 of the module 14 is magnetically securable to the backing plate 12 at a plurality of positions on the backing plate 12. For example, in FIG. 1, it may be imagined that the modules 14 may be moved to any position on the backing plate 12, as required by the user. In fact, due to its magnetic securement, the positions whereat the base portion 16 may be secured to the backing plate 12 are virtually unlimited. This allows the user to arrange the system 10 in any desirable configuration, which is of tremendous benefit to retailers who must continually update and manipulate their displays. Referring again to FIGS. 2 and 4, upon being secured to the backing plate 12, the utility member 18 of the module 14 projects outwardly from the base portion 16 and is sized and configured to receive the item for display. As such, the utility member 18 may receive such items as hats, clothing hung on hangers, shoes, boxed merchandise, etc.

As shown in FIG. 1, the backing plate 12 may be sized and configured to cover a majority of a wall structure 20. As shown in FIGS. 1 and 3, the backing plate 12 is preferably designed as a sheet of metal that is at least 1/32 inch thick. However, typical plate thickness may be from at least 1/16 to ¼ inch. It has been found that increasing the thickness of the backing plate 12 further enhances the magnetic attraction between the base portion 16 of the module 14 and the backing plate 12. Therefore, it is contemplated that the thickness of the backing plate 12 may directly correspond to the application for which the system 10 is intended. For example, if the modules 14 are to be moderately load-bearing, it may be preferable to use a backing plate 12 of greater thickness, such as ⅛ to ¼ inch thick. As discussed further below, the thickness of the backing plate 12 may also correspond to the module 14 specifications in order to ensure sufficient magnetic securement of the base portion 16 of the module 14 to the backing plate 12. Further, the backing plate 12 may be made of any of a variety of metallic materials known in the art.

As shown in FIG. 1, the backing plate 12 may be attached to existing wall structures 20. The wall structure 20 may be an existing structurally load-bearing wall, or a free-standing wall. For example, the wall structure 20 may be constructed of a framework, such as made of wood, metal, or other materials, may be assembled and utilized as the wall structure 20 onto which the backing plate 12 may be mounted. In this embodiment, the system 10 and backing plate 12 may take the form of a glass jewelry display case mounted to the wall structure 20, amongst others. When the user desires to utilize the system 10 as a free-standing display, the user may construct the framework as required, and place the framework as desired. This would allow significant mobility and use of the system 10 in any variety of situations and store layouts. In this embodiment, the system 10 and binding plate 12 may be a free-standing jewelry case with legs, amongst others.

The backing plate 12 may also be variously configured. The backing plate 12 may be attached to the wall structure 20 may be accomplished utilizing means known in the art. In some instances, the backing plate 12 may be designed to cover the entirety of a wall, from floor to ceiling. In other instances however, the size of the backing plate 12 may be optimized to cover only a portion of the wall such as from approximately 1-2 feet off of the floor to 8-10 feet in height. Such an optimized size of the backing plate 12 may be determined by the user and correspond to the layout of the wall structure 20 and the location, as well as the needs of the user. For example, if the user intends to utilize the system 10 to display items that are to be sold to customers, the user may need each item displayed with the system 10 to be within reach of the average customer. Thus, the backing plate 12 need only reach 6 feet from the floor. This would not only meet the needs of the user, but would also require less material and therefore be a more economical alternative than covering the entirety of the wall structure 20. In other situations, the user may wish to limit the size of the backing plate 12 to correspond only to specific sections of the wall structure 20, such as a column. In such situations, the backing plate 12 may easily be designed and installed according to user requirements. Such calculations and modifications of the backing plate 12 relative to the wall structure 20 may therefore be performed in response to user requirements.

Referring now to FIG. 3, the backing plate 12 may also be mounted on a support sheet 22. This arrangement may be beneficial when the backing plate 12 is of a lesser thickness or smaller in size. The support sheet 22 may be any of a variety of natural or synthetic wood products, such as boards or constructed frames. In particular, fiberboard is a useful product that may serve as the support sheet 22. Medium density fiber board (“MDF”) may be the preferred fiberboard due to its high strength properties and low cost. Nevertheless, other types of fiberboard and wood products may be utilized. Further, it may be desirable to construct the support sheet 22 as a framework, such as made of metal, wood, or other materials, which would provide maximum support and rigidity to the backing plate 12 without significantly increasing the combined weight of the backing plate 12 and support sheet 22. This may be advantageous when utilizing large sized backing plates. Thus, the use of frames may reduce the weight of the support sheets. Otherwise, as shown in FIG. 3, the support sheet 22 may include a plurality of perforations in order to be lighter and easier to handle. Preferably, the support sheet 22 should be configured to ensure easy handling and minimal weight cost.

As mentioned above, one of the significant advantages of embodiments of the present invention is that the system 10 may be manipulated to be aesthetically pleasing as desired by the user. One of the prevalent drawbacks of prior art shelving assemblies and wall fixtures is that the assemblies and fixtures are not only unsightly, but also make it difficult for the user to decorate the wall because the assemblies and fixtures must be removed and reinstalled each time the user desire to reconfigure the assembly or fixture. In this regard, the backing plate 12 may include a surface covering 24 suited to the tastes and aesthetic needs of the user. The user may manipulate the surface covering 24 so that the backing plate 12 appears to be a normal wall or take on any appearance desirable by the user. For example, the surface covering 24 may be a simple coat of paint, powder coating, wallpaper, or also may include other products such as suede, leather, wood veneer, laminate, and fabrics. The surface covering 24 may also be any combination of materials desired by the user. Preferably, the surface covering 24 should be thin enough not to interfere with the magnetic securement of the module 14. However, if a thicker surface covering 24 is desired, the module 14 may be alternatively configured to ensure proper magnetic securement despite the thickness of the surface covering 24. In some instances, the user may prefer a metallic surface covering, which may be simply obtained by polishing the backing plate. Therefore, the flexibility of including the surface covering 24 allows the user to experiment with and to employ any design or pattern that they wish.

Once the backing plate 12 is properly mounted and finished with the surface covering 24 (as desired by the user), the user may then place the modules 14 onto the backing plate. The system 10 may include multiple modules 14, and the modules 14 may be of differing designs. For example, referring again to FIG. 1, several modules 14 of differing design may be arranged according to user requirements such as to display hats, hang clothing, or other numerous merchandise and articles. As mentioned above, another advantage of the system 10 is that the user is not limited to a discrete number of positions whereat the modules 14 may be mounted. Instead, the user may place the modules 14 at certain positions on the backing plate 12, visually inspect the system 10, and make any adjustments as necessary.

Referring now to FIGS. 2 and 4-7, the module 14 may be configured in a variety of configurations in order to meet the needs of the user. As mentioned above, the module 14 includes the base portion 16 and the utility member 18. Although primarily illustrated as being rectangular and planar in shape, the base portion 16 may be designed as a planar circle, three-dimensionally hemispherical, or may include any variety of designs, including any variety of cutting, bending, forming, etc. The base portion 16 may be decoratively designed in response to user requirements.

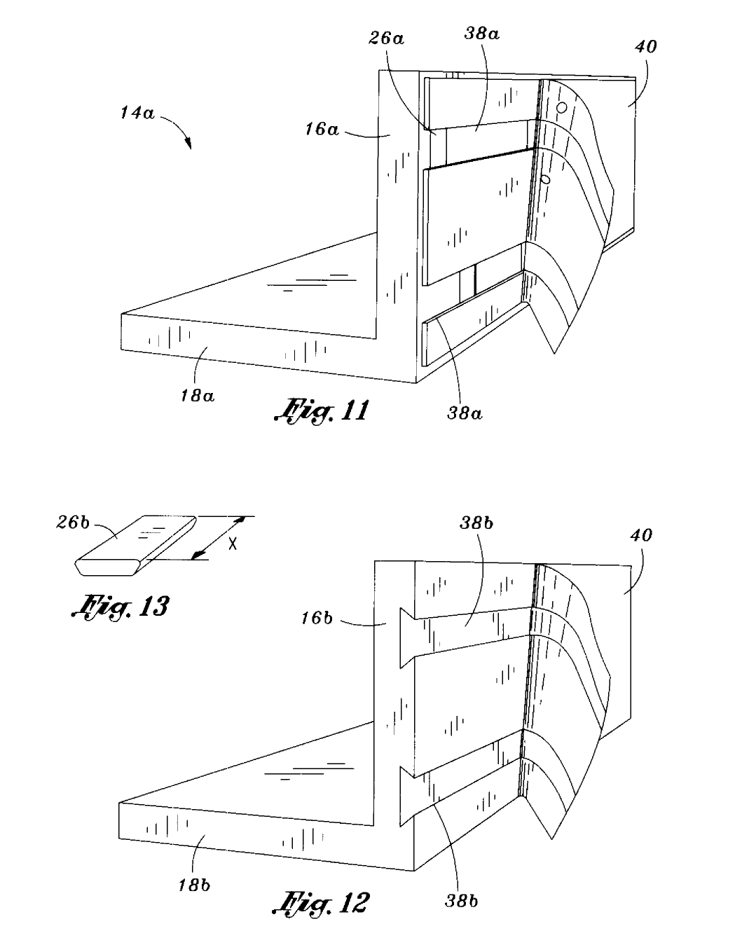

The base portion 16 of the module 14 is utilized to magnetically secure the module 14 to the backing plate 12. The base portion 16 of the module 14 may vary in size corresponding to the configuration of the utility member 18 used on the module, as further described below. The dimensions of the base portion 16 may therefore be determined in response to the utility member 18 and the intended use (such as loading capacity) of the module 14. Magnetic securement of the module 14 may be accomplished in a variety of ways. For example, the base portion 16 itself may be magnetic. However, in preferred embodiments of the invention, best illustrated in FIGS. 2, 4, 5, 7, and 9, the module 14 includes a magnetic element 26 that is affixed to the base portion 16 of the module 14. The magnetic element 26 may therefore serve to create the magnetic securement between the base portion 16 and the magnetic backing plate 12 at the plurality of positions described above. The magnetic element 26 may be attached to the base portion 16, or as mentioned, may be integral with the base portion 16. The magnetic element 26 may be adhesively attached to a rear surface of the base portion 16 as shown illustratively in FIGS. 5 and 9. Such adhesion may be performed utilizing epoxy, super glue, or other suitable adhesives. In addition, the magnetic element 26 may be recessed within the base portion 16. In another embodiment of the present invention, the magnetic element 26 may be attached to the base portion 16 by a fastener 40, such as a screw as depicted in FIG. 10.

The magnetic element 26 may be one of a variety of materials that exhibits desirable magnetic properties. For example, a preferred magnetic element 26 includes neodymium magnets 28. As best shown in the rear perspective views of FIGS. 5 and 9, it is preferable to include at least three separate magnets 28 that are attached to the base portion 16. The triangular arrangement of the magnets 28 illustrated in FIG. 5 provides a high degree of magnetic securement between the module 14 and the magnetic backing plate 12 when the module 14 is smaller in size. However, for larger elongate modules 14, such as that illustrated in FIGS. 2 and 9, the magnetic element 26 may be four or more separate magnets 28. Preferably, the least amount of magnets should be used—the proper arrangement of the magnets may allow this economizing of magnets to result in proper magnetic securement. Of course, specific calculations for determining load bearing capacity and magnetic securement may be performed and modifications may be made based on the needs of the user. In this regard, such calculations and modifications, including use of substitute magnetic materials, may be performed by one of skill in the art. Thus, the magnetic element 26 may be variously designed to provide optimal magnetic securement for the module 14 on the backing plate 12.

Furthermore, the module 14 includes the utility member, which may be designed in various configurations, some of which are illustrated in FIGS. 2 and 4-5. As indicated, one of the principal purposes of the utility member 18 is to fulfill the display needs of the user. Thus, the utility member 18 may broadly include the use of any type of device, pole, branding tile, mirror, light, writing board, etc., just to name a few. Other exemplary embodiments of the utility member 18 are provided as follows.

For example, the utility member 18 may be a ledge 30, as illustrated in FIG. 2. The ledge 30 may be sufficiently wide and protrude at a desirable distance from the base portion 16 in order to provide usable space whereon the user may place items for display. Preferably, the ledge 30 is disposed perpendicularly to the base portion 16. The ledge 30 may be formed integrally with the base portion, and the module 14 may therefore be formed from a single sheet of material that is formed into the base portion 16 and the ledge 30 by creating a bend in the module 14. However, as illustrated in FIG. 2, the module 14 may further include a shelf 32 that is mountable to the ledge 30. As shown in FIG. 2, the shelf 32 may be sized and configured to be perpendicularly disposed relative to the wall and to the base portion 16. In this regard, the shelf 32 may also be mounted to the ledge 30 with a rear edge of the shelf 32 contacting the backing plate. This configuration may tend to enhance the rigidity of the shelf 32 by reducing any horizontal and vertical displacement of the shelf 32 when an item is placed at a distal edge of the shelf 32. The mounting of the shelf 32 to the ledge 30 may be accomplished by fasteners or by adhesives known in the art.

In addition, the utility member 18 of the module 14 may also be configured as a hook 34, as shown in FIG. 4, if the user needs only to display a hat or hang the item thereon. As shown in FIGS. 4 and 6, the utility member 18 may include a cylindrical bar that protrudes orthogonally from the base member. The cylindrical configuration of the utility member 18 is preferable in light of the low impact that the cylindrical configuration may have on the items that may be hung thereon—in particular, the rounded surface of the utility member 18 may ensure that no hard edges contact the item, which should be protected and maintained in pristine condition. The utility member 18 may also include the hook 34 at a distal end thereof for retaining items on the utility member 18. However, it is also contemplated that the utility member 18 may be oriented and protrude upwardly at an acute angle with respect to the base portion 16. Such a configuration may allow the utility member 18 to retain the item thereon due to the exertion of gravity on the item. Indeed, the utility member 18 may be variously sized and configured to provide maximum utility for the user. For example, the utility element may include a spherical knob at the distal portion thereof, may be shaped as a horn, or may include a plurality of hooks or bars whereon multiple items may be hung. In addition, the utility member 18 may be configured to be a unique decorative symbol, and may likewise be decorated, painted, textured, or otherwise designed to fit the aesthetic needs of the user.

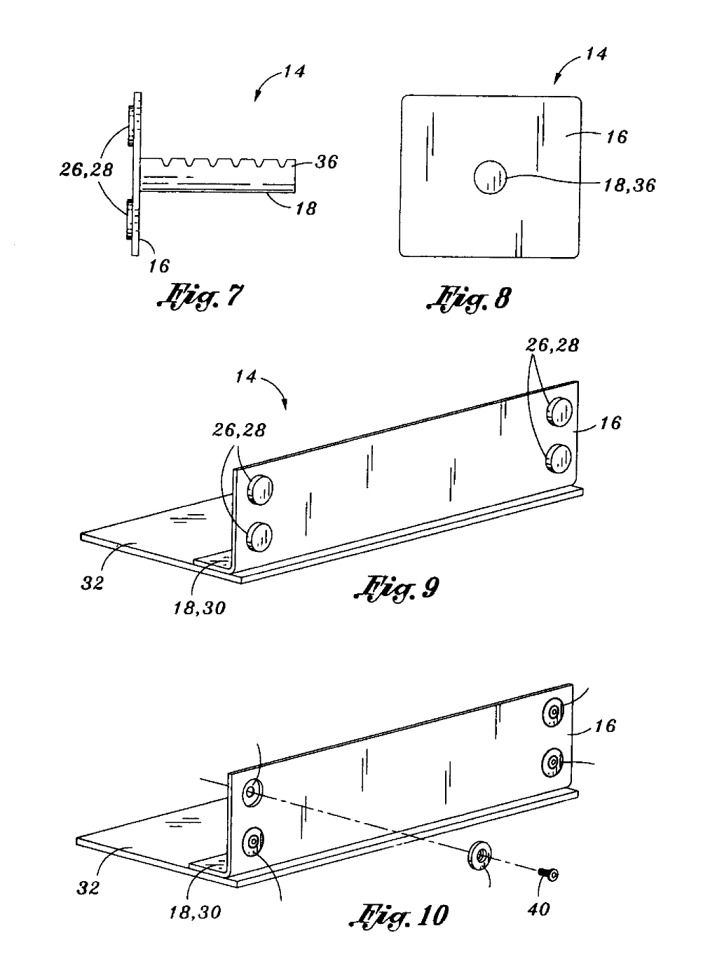

Furthermore, other configurations for the utility member 18 may include a notched bar 36, as shown in FIGS. 7 and 8. The notched bar 36 may include a series of notches sized and configured to receive hangers or other items. As mentioned briefly above, FIG. 9 illustrates the module 14 including the ledge 30 and the shelf 32. Such an embodiment also serves to illustrate that the base portion 16 of the module 14 may be considerably wider than tall, thus allowing great flexibility in determining the length of shelving. However, although FIG. 9 illustrates the utility member 18 including the ledge, it is also contemplated that there may be multiple utility members attached to the base portion 16. Thus, a series of hooks 34 or notched bars 36 may be attached to the base portion 16. The variety of configurations illustrated and described herein are given by way of example, and it is contemplated that numerous other designs and configurations may be developed in response to user requirements.

Referring now to FIG. 11, there is shown a module 14a constructed in accordance with an alternative embodiment of the present invention. Like the above-described module 14, the module 14a includes a utility member 18a which is identically configured to the above-described utility member 18. The module 14a also includes a base portion 16a which differs from the base portion 16 of the module 14 in the manner which will be described in more detail below.

As explained above in relation to the module 14, the base portion 16 of the module 14 includes a plurality of magnetic elements 26 attached to the back surface thereof opposite that having the utility member 18 protruding therefrom. More particularly, the magnetic elements 26 are rigidly secured to the generally planar back surface of the base portion 16 such that the magnetic elements 26 are permanently maintained in prescribed positions thereon.

In the module 14a, the back surface of the base portion 16a does not have a generally planar configuration, but rather includes a pair of elongate channels 38 formed therein in spaced, generally parallel relation to each other. As seen in FIG. 11 each of the channels 38 is formed to have a generally quadrangular (e.g., rectangular) cross-sectional configuration. In the module 14a, each of the channels 38 is sized and configured to slidably accommodate one or more magnetic elements 26a, each of which has a generally rectangular configuration complimentary to that of the channels 38. As will be recognized by those of ordinary skill in the art, the length, number and/or spacing of the magnetic elements 26a inserted into each of the channels 38 may be based upon the amount of weight-bearing capacity required for the module 14a. To assist in preventing the magnetic elements 26a from falling out of the channels 38, the module 14a is preferably provided with a backing sheet 40 which is releasably attachable to the back surface of the base portion 16a. When attached to the back surface of the base portion 16a, the backing sheet 40 completely encloses the channels 38, except for each of the opposed ends thereof. As will be recognized, the addition or removal of one or more magnetic elements 26a from within one or both of the channels 38 may easily be facilitated subsequent to the removal of the backing sheet 40 from the back surface of the base portion 16.

It is contemplated that each of the channels 38 may be formed within the back surface of the base portion 16a by the completion of a suitable routing process through the use of a common router bit or similar tool. Alternatively, the channels 38 may each be defined by attaching a series of generally planar, sheet-like elements to the back surface of the base portion 16a in prescribed spatial relationships relative to each other. Advantageously, the configuration of the module 14a allows the base portion 16a thereof to be fabricated from materials such as wood, plastic or aluminum. As will be recognized, once the magnetic element(s) 26a are advanced into the channels 38 and the backing sheet 40 applied to the back surface of the base portion 16a in the above-described manner, the module 14a is used in the same manner described above in relation to the module 14, i.e., the back surface of the base portion 16a having the magnetic elements 26a disposed within the channels 38 thereof may be magnetically secured to the magnetic backing plate 12. Though the base portion 16a is preferably provided with the spaced, generally pair of channels 38 shown in FIG. 11, those of ordinary skill in the art will recognize that the back surface of the base portion 16a may be provided with only a single channel 38 which accommodates one or more magnetic elements 26a, without departing from the spirit and scope of the present invention. Additionally, the width of each of the channels 38 shown in FIG. 11 is intended to be exemplary only, the formation of the channels 38 or a single channel 38 to each be of a width differing from that shown in FIG. 11 also being within the spirit and scope of the present invention.

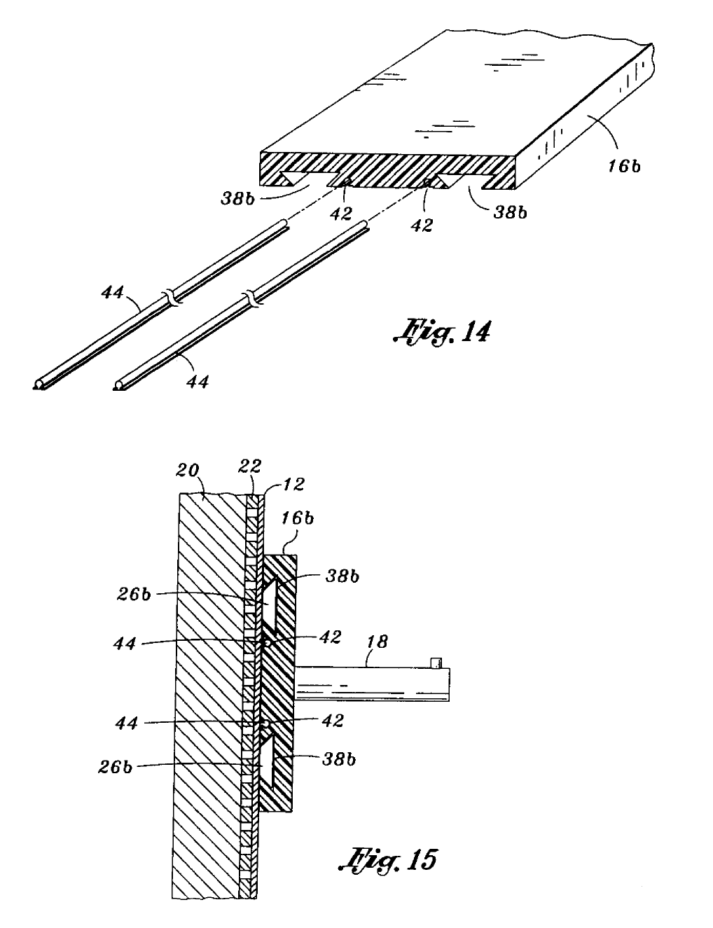

Referring now to FIG. 12, there is shown a base portion 16b which may be integrated into the above-described module 14a as an alternative to the base portion 16a. In this regard, the sole distinction between the base portions 16a, 16b lies in the shape or configuration of the channels 38b of the base portion 16b in comparison to the channels 38 of the base portion 16a. More particularly, each of the channels 38b has a generally trapezoidal (i.e., dove-tail) cross-sectional configuration, as opposed to having the rectangular cross-sectional configuration described above in relation to the channels 38. Along theses lines, the magnetic elements 26b used in conjunction with the base portion 16b (as shown in FIG. 13) also each have a generally complimentary trapezoidal cross-sectional configuration, and are sized to be slidably inserted into and moveable within respective ones of the channels 38b. Advantageously, the complimentary, dove-tail configurations of the channels 38b and magnetic elements 26b allows the magnetic elements 26b to be maintained within respective ones of the channels 38b without the need for the use of the backing sheet 40 described above in relation to the module 14a. It is contemplated that the channels 38b will be formed within the back surface of the base portion 16b through the completion of a suitable routing process. Alternatively, the base portion 16b may be fabricated through the completion of an extrusion process which facilitates the formation of the channels 38b. As with the base portion 16a described above, the base portion 16b may be provided with a single channel 38b rather than the spaced, generally pair thereof shown in FIG. 12. Also, the length, number, and/or spacing of the magnetic elements 26b in the base portion 16b may be varied, depending upon the weight of the object supported by the module 14a.

Referring now to FIG. 14, in yet another embodiment of the present invention, there is shown a base portion 16b with a gutter 42 adjacent to each channel 38b formed by a routing or extrusion process comparable to the formation of the channels 38b. Each of the gutters 42 has a generally cylindrical cross-sectional configuration as shown in FIG. 14, with each of the pads 44 used in conjunction with the gutters 42 also having a generally complimentary cylindrical cross-sectional configuration, and are sized to be slidably inserted into and movable within respective ones of the gutters 42. The pads 44 may be made of a non-slick material such as rubber. Advantageously, the complimentary, dove-tailed configurations of the gutters 42 and pads 44 enable the base portion 16b to be stabilized against the face of the backing plate 12 and to prevent the scratching of the surface of the backing plate 12. As described above, the interval, spacing and number of gutters 42 and complimentary pads 44 may be configured so as to account for the amount of weight-bearing capacity required for the module 14. FIG. 15 depicts a cross-sectional view in one embodiment of the placement of the pads 44 and gutters 42 in reference to the base portion 16 and the magnetic elements 26b in the system 10.

The above description is given by way of example, and not limitation. Given the above disclosure, one skilled in the art could devise variations that are within the scope of the invention disclosed herein, including various ways of manufacturing and using the module 14 and system 10. Further, the various features of the embodiments disclosed herein can be used alone, or in varying combinations with each other and are not intended to be limited to the specific combination described herein. Thus, the scope of the claims is not to be limited by the illustrated embodiments.

1. A module for use in a modular magnetic wall system, the module comprising:
a base portion defining opposed front and back surfaces, the base portion including a pair of channels disposed within and extending along the back surface of the base portion in spaced, generally parallel relation to each other;
a utility member protruding from the front surface of the base portion; and
a plurality of magnetic elements disposed within respective ones of the pair of channels of the base portion.

2. The module of claim 1 further comprising a backing sheet which is releasably attached to the back surface of the base portion and is operative to at least partially enclose the pair of channels when attached to the back surface.

3. The module of claim 1 wherein the pair of channels and the plurality of magnetic elements have complimentary, generally quadrangular cross-sectional configurations.

4. (canceled)

5. (canceled)

6. (canceled)

7. The module of claim 1 wherein the pair of channels and the plurality of magnetic elements have complimentary, generally trapezoidal cross-sectional configurations.

8. The module of claim 1 wherein the base portion includes three channels disposed and extending within the back surface thereof in spaced, generally parallel relation to each other.

9. The module of claim 1 wherein the plurality of magnetic elements are spaced from each other at a fixed distance.

10. The module of claim 1 further comprising an elongate gutter disposed in the back surface of the base portion proximate to the pair of channels.

11. The module of claim 10 further comprising at least one pad disposed within the gutter.

12. (canceled)

13. (canceled)

14. (canceled)

15. (canceled)

16. (canceled)

17. (canceled)

18. (canceled)

19. (canceled)

20. (canceled)

21. The module of claim 1, wherein the plurality of magnetic elements are sized and configured to be slidable within the respective ones of the pair of elongate channels to facilitate selective placement of the plurality of magnetic elements within the pair of elongate channels.

22. The module of claim 1, wherein each elongate channel extends along a channel axis, each elongate channel being configured to enable slidable movement of the plurality of magnetic elements along the channel axis, and to mitigate removal of the plurality of magnetic elements from the respective one of the pair of elongate channels in a direction orthogonal to the respective channel axis.

23. A module for use in a modular magnetic wall system, the module comprising:
a base portion defining opposed front and back surfaces, the base portion having an elongate channel formed in the back surface of the base portion;
a utility member protruding from the front surface of the base portion; and
a magnetic element disposed within the elongate channel, the magnetic element being sized and configured to be slidable within the elongate channel to facilitate selective placement of the magnetic element within the elongate channel.

24. The module of claim 23, wherein the elongate channel extends partially through the base portion from the back surface toward the front surface.

25. The module of claim 23, wherein the elongate channel extends along a channel axis, the elongate channel being configured to enable slidable movement of the magnetic element along the channel axis, and to mitigate removal of the magnetic element from the elongate channel in a direction orthogonal to the channel axis.

26. The module of claim 23, wherein the elongate channel and the magnetic element define complimentary, generally quadrangular cross-sectional configurations.

27. The module of claim 23, wherein the elongate channel and the magnetic element define complimentary, generally trapezoidal cross-sectional configurations.

28. A module for use in a modular magnetic wall system, the module comprising:
a base portion defining opposed front and back surfaces, the base portion having a pair of elongate channels formed in the back surface of the base portion;
a utility member protruding from the front surface of the base portion; and
a plurality of magnetic elements disposed within respective ones of the pair of elongate channels, each magnetic elements being sized and configured to be slidable within the respective one of the pair of elongate channels to facilitate selective placement of the magnetic element within the respective one of the pair of elongate channels.

29. The module of claim 28, wherein the pair of elongate channels are disposed in spaced, parallel relation to each other.

30. The module of claim 28, wherein each of the elongate channels extends partially through the base portion from the back surface toward the front surface.

31. The module of claim 28, wherein each elongate channel extends along a respective channel axis, each elongate channel being configured to enable slidable movement of respective ones of the plurality of magnetic elements along the channel axis, and to mitigate removal of the respective ones of the plurality of magnetic elements from the elongate channel in a direction orthogonal to the respective channel axis.
